(19) United States
(12) Patent Application Publication
(10) Pub. No.: US 2022/0306830 A1
(43) Pub. Date: Sep. 29, 2022

(54) PRESSURE SENSITIVE ADHESIVE HAVING BROAD COMPATIBILITY WITH NON-HALOGENATED FLAME RETARDANTS

(71) Applicant: 3M INNOVATIVE PROPERTIES COMPANY, St. Paul, MN (US)

(72) Inventors: Ibrahim A. El Hedok, Concord, NC (US); Eumi Pyun, St. Paul, MN (US); Michael D. Zenner, Hudson, WI (US); Anna K. Davy, Apple Valley, MN (US); Mahfuza B. Ali, Mendota Heights, MN (US)

(21) Appl. No.: 17/637,032

(22) PCT Filed: Aug. 10, 2020
(86) PCT No.: PCT/IB2020/057516

§ 371 Date: Feb. 21, 2022

Related U.S. Application Data
(60) Provisional application No. 62/893,255, filed on Aug. 29, 2019.

(51) Int. Cl. C08K 3/016; C09J 7/38; C09J 11/04; C09J 11/06; C09J 133/14; C08K 3/32

(52) U.S. Cl. CPC C08K 3/016; C09J 7/385; C09J 11/04; C09J 11/06; C09J 133/14; C08K 3/32; C08K 2003/323; C09J 2301/302; C09J 2301/408; C09J 2433/00

(57) ABSTRACT

A fire resistant (FR) pressure sensitive adhesive (PSA) comprises a blend of: a) a (meth)acrylate polymer comprising cationic monomer units; and b) a non-halogenated flame retardant. In some embodiments, the cationic monomer units comprise cationic quaternary amine groups. The (meth)acrylate polymer may additionally comprise anionic monomer units, in which case the molar ratio of anionic monomer units present in the polymer to cationic monomer units present in the polymer is typically less than 0.9. The FR PSA may be aqueous based and may be free of common solvents. The FR PSA may demonstrate improved flame retardance with good compatibility between PSA and flame retardant, and may retain compatibility even at high loadings of flame retardant.

### FIELD OF THE DISCLOSURE

This disclosure relates to fire resistant pressure sensitive adhesives comprising (meth)acrylate polymers comprising cationic monomer units and non-halogenated flame retardants.

### BACKGROUND OF THE DISCLOSURE

Pressure sensitive adhesive (PSA) tapes are used in a variety of applications where fire risk is a major concern, such as in aircraft, automobiles, trains, ships, building construction, and in conjunction with electronics and electrical wiring. Since polymer-based PSA's are typically flammable, a variety of flame retardants are added to minimize the fire risk associated with the use of polymeric PSA's. Flame retardants reduce the flammability of materials by a variety of mechanisms, including: quenching free radicals in the gas phase, reacting with chemical fragments from the burning material to initiate char formation, and forming barrier layers within the burning material.

Commonly used flame retardants include halogenated compounds such as polychlorinated biphenyl and polybrominated diphenyl ethers. These flame retardants are well-known and very efficient at fire retardation in combustible materials. However, many compounds in this class of flame retardants are considered hazardous substances. Several of the most effective halogenated flame retardants have been banned by the European Union under the Restriction of Hazardous Substances (RoHS) since Jul. 1, 2006. Other countries and individual states of the United States are also following with similar RoHS directives.

Phosphorus-based compounds are a leading class of non-halogenated flame retardants which have been applied successfully to replace halogenated flame retardants in many applications. Ammonium polyphosphates (APP) are among the most effective non-halogenated flame retardants; however, they have limited compatibility with polymeric PSA materials. Metal hydroxides, zinc borates, and melamine particles are also effective non-halogenated flame retardants, but also have limited compatibility.

In addition, solvent-free adhesives are increasingly preferred for lower environmental impact.

The following references may be relevant to the general field of technology of the present disclosure: WO 2014/093375 A1; U.S. Pat. Nos. 5,612,136; 6,479,073; 7,005,031; TW 1577766 B; CN 102391800 B; CN 10165604; and CN 1331267 A.

### SUMMARY OF THE DISCLOSURE

Briefly, the present disclosure provides a fire resistant (FR) pressure sensitive adhesive (PSA) comprising a blend of: a) a (meth)acrylate polymer comprising cationic monomer units; and b) a non-halogenated flame retardant. In some embodiments, the cationic monomer units comprise cationic quaternary amine groups, and may comprise at least 2 wt % of the polymer. In some embodiments, the (meth)acrylate polymer additionally comprises anionic monomer units, i.e., is zwitterionic, in which case the molar ratio of anionic monomer units present in the polymer to cationic monomer units present in the polymer is typically less than 0.9. In some embodiments, the adhesive comprises essentially no common solvents. In various embodiments, the flame retardant is selected from the group consisting of phosphorus-containing flame retardants, melamine-containing flame retardants, clays, metal hydroxides, and zinc borates. The adhesive may comprise at least 5 wt % of the flame retardant based on the total weight of polymer plus flame retardant, but may additionally comprise up to 50 wt % of the flame retardant without losing compatibility between the polymer and the flame retardant. The flame retardant may be present in aqueous solution, or as a particulate flame retardant, or both. Particulate flame retardants may be of small median particle size (Dv50); less than 20 micrometers, less than 10 micrometers, or even less than 7 micrometers. Additional embodiments of the FR PSA of the present disclosure are described below under “Selected Embodiments.”

The preceding summary of the present disclosure is not intended to describe each embodiment of the present invention. The details of one or more embodiments of the invention are also set forth in the description below. Other features, objects, and advantages of the invention will be apparent from the description and from the claims.

In this Application:

“common solvents” refers to low molecular weight organic liquids commonly used as solvents by practitioners in the art, which may include aliphatic and alicyclic hydrocarbons (e.g., hexane, heptane, and cyclohexane), aromatic solvents (e.g., benzene, toluene, and xylene), ethers (e.g., diethyl ether, glyme, diglyme, diisopropyl ether, and tetrahydrofuran), esters (e.g., ethyl acetate and butyl acetate), alcohols (e.g., ethanol and isopropyl alcohol), ketones (e.g., acetone, methyl ethyl ketone, and methyl isobutyl ketone), sulfoxides (e.g., dimethyl sulfoxide), amides (e.g., N,N-dimethylformamide, N,N-dimethylacetamide, and N-methyl-2-pyrrolidone), halogenated solvents (e.g., methylchloroform, 1,1,2-trichloro-1,2,2-trifluoroethane, trichloroethylene, and trifluorotoluene), and mixtures thereof; providing that “common solvents” excludes species that act as monomers or otherwise as reactants in a given composition;

“essentially no” amount of a material in a composition may be substituted with “less than 5 weight percent”, “less than 4 weight percent”, “less than 3 weight percent”, “less than 2 weight percent”, “less than 1 weight percent”, “less than 0.5 weight percent”, “less than 0.1 weight percent”, or “none”;

“(meth)acrylate” includes, separately and collectively, methacrylate and acrylate;

“(meth)acrylate polymer” includes, separately and collectively, polymers containing methacrylate monomer units, polymers containing acrylate monomer units, and polymers containing both methacrylate and acrylate monomer units;

“monomer unit” of a polymer or oligomer is a segment of a polymer or oligomer derived from a single monomer;

“normal temperature and pressure” or “NTP” means a temperature of 20° C. (293.15 K, 68° F.) and an absolute pressure of 1 atm (14.696 psi, 101.325 kPa); and “pressure sensitive adhesive (PSA)” means materials having the following properties: a) tacky surface, preferably aggressive and permanent tack, b) the ability to adhere with no more than finger pressure, c) the ability to adhere without activation by any energy source, d) sufficient ability to hold onto the intended adherend, and preferably e) sufficient cohesive strength to be removed cleanly from the adherend; which materials typically meet the Dahlquist criterion of having a storage modulus at 1 Hz and room temperature of less than 0.3 MPa.

All scientific and technical terms used herein have meanings commonly used in the art unless otherwise specified.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

### BRIEF DESCRIPTION OF THE DRAWING

FIG. 1 is a photograph of test strips of Example 1 and Comparative Examples CE1 and CE2 after the First Modified UL 94VTM flame test procedure procedure was performed, as described in the Examples section.

FIG. 2 is a photograph of test strips of Examples 2-5 after the First Modified UL 94VTM flame test procedure was performed, as described in the Examples section.

### DETAILED DESCRIPTION

The present disclosure provides fire resistant (FR) pressure sensitive adhesives (PSA's) comprising blends of a) (meth)acrylate polymers comprising cationic monomer units, and b) non-halogenated flame retardants. While non-halogenated flame retardants typically have limited compatibility with such materials, the present blends are found to be both compatible, in that they do not gel, and flame resistant.

As demonstrated in the Examples below, non-halogenated flame retardants tend to have poor compatibility with typical water-based (meth)acrylate PSA materials, which are typically anionic. In such mixtures, the ionic particles agglomerate causing the solution to gel. However, we have found that water-based (meth)acrylate polymers containing cationic groups can be highly compatible with non-halogenated flame retardants. In addition, we have found that embodiments of FR PSA's according to the present invention show improved performance in burn testing, when compared to commercial water-based adhesives containing the same loading of flame retardant additives. This indicates a synergy between the cationic groups of the (meth)acrylate polymer and the flame retardants. FR PSA's according to the present invention demonstrate both solution compatibility and improved flame retardancy without the use of halogenated flame retardants or solvents.

In some embodiments the blend is solvent-free. In some embodiments, the blend is aqueous. Aqueous emulsions of the FR PSA's are also contemplated.

### Non-Halogenated Flame Retardants

Any suitable non-halogenated flame retardants may be used in the practice of the present invention. Suitable non-halogenated flame retardants may include phosphorus-containing flame retardants, melamine-containing flame retardants, clays, metal hydroxides, or zinc borates. Suitable non-halogenated flame retardants may include ammonium pyrophosphate, ammonium polyphosphate, diethyl phosphinate, ethylene diamine phosphate, melamine pyrophosphate, melamine polyzinc phosphate, melamine polymagnesium phosphate, melamine zinc phosphate, piperazine phosphate, pyrophosphoric acid salt, 9,10-Dihydro-9-oxa-10-phosphaphenanthrene 10-oxide, hydroxyphenyl phosphinyl propanoic acid, magnesium hydroxide, alumina trihydrate, melamine cyanurate, melamine, clays such as montmorillinite clay, and zinc borate. Preferably, the flame retardant comprises phosphorus, more preferably phosphate, and more preferably ammonium phosphate.

The non-halogenated flame retardants may be present in any suitable amount in the FR PSA's of the present invention. As demonstrated in the Examples below, the practice of the present invention allows high loadings, e.g., 50 weight percent, without loss of compatibility. In various embodiments, the FR PSA's may comprise at least 5 wt % of the flame retardant based on the total weight of polymer plus flame retardant, at least 10 wt %, at least 15 wt %, at least 20 wt %, at least 25 wt %, at least 30 wt %, at least 35 wt %, at least 40 wt %, at least 45 wt %, at least 48 wt %, or at least 50 wt %. In any of these embodiments, upper limits to the flame retardant content may optionally be set at 90 wt %, 80 wt %, 70 wt %, 60 wt %, 50 wt %, 40 wt %, or 30 wt %.

The non-halogenated flame retardants may be present in particulate form, dissolved in aqueous solution, or both. In one embodiment, we have found that by adding both particulate non-halogenated flame retardants and non-halogenated flame retardants dissolved in aqueous solution, the viscosity of the resulting water-borne PSA may be adjusted by adjusting the ratio between particulate and dissolved flame retardant without compromising flame retardancy. As demonstrated in the Examples below, we have found that when particulate flame retardants are used, smaller particle size leads to improved flame retardancy. In some embodiments, the particulate flame retardant has median particle size (Dv50) of less than 20 micrometers, in some less than 18 micrometers, in some less than 10 micrometers, in some less than 7 micrometers, and in some less than less than 6 micrometers. Optionally, particle size can be subject to a lower limit of 1 micrometer, 2 micrometers, or 4 micrometers.

### PSA (Meth)acrylate Polymers

Any suitable PSA (meth)acrylate polymer comprising cationic monomer units may be used in the practice of the present invention. The (meth)acrylate polymer may be such that at least 20% of the monomer units of the polymer are derived from (meth)acrylate monomers, at least 30%, at least 40%, at least 50%, at least 60%, at least 70%, at least 80%, or at least 90%. Typical PSA (meth)acrylate polymers include as monomers (meth)acrylate esters of linear, branched, or cyclic alcohols having between 4 and 20 carbons, including, as representative examples, butyl acrylate, 2-ethyl hexyl acrylate, isooctyl acrylate, and isobornyl acrylate. Other monomer units of the polymer may be derived from suitable radically polymerizable unsaturated monomers, including, as representative examples, vinyl acetate and styrene. In some embodiments, the PSA (meth)acrylate polymers may additionally comprise crosslinking monomers, such as polyfunctional monomers, including, as representative examples, 1,6-hexanediol diacrylate.

The PSA (meth)acrylate polymer may comprise any suitable cationic monomer units. In some embodiments, the cationic monomer units comprise cationic quaternary amine groups or N-vinylimidazole salts including, as representative examples, N,N-dimethylaminoethyl acrylate methyl chloride quaternary and N-vinylimidazole HCl.

In some embodiments, the cationic monomer is an acrylate or methacrylate ester including an alkylammonium functionality. In some embodiments, the cationic monomer is a 2-(trialkylammonium)ethyl acrylate or a 2-(trialkylammonium)ethyl methacrylate. In such embodiments, the nature of the alkyl groups is not particularly limited; however, cost and practicality limit the number of useful embodiments. In embodiments, the 2-(trialkyl ammonium)ethyl acrylate or 2-(trialkylammonium)ethyl methacrylate is formed from the reaction of 2-(dimethylamino)ethyl acrylate or 2-(dimethylamino)ethyl methacrylate with an alkyl halide; in such embodiments, at least two of the three alkyl groups of the 2-(trialkyl ammonium)ethyl acrylate or 2-(trialkylammonium)ethyl methacrylate are methyl. In some such embodiments, all three alkyl groups are methyl groups. In other embodiments, two of the three alkyl groups are methyl and the third is a linear, branched, cyclic, or alicyclic group having between 2 and 24 carbon atoms, or between 6 and 20 carbon atoms, or between 8 and 18 carbon atoms, or 16 carbon atoms. In some embodiments, the cationic monomer is a mixture of two or more of these compounds. The anion associated with the ammonium functionality of the cationic monomer is not particularly limited, and many anions are useful in connection with various embodiments of the invention. In some embodiments, the anion is a halide anion, such as chloride, bromide, fluoride, or iodide; in some such embodiments, the anion is chloride. In other embodiments the anion is BF₄, N(SO₂CF₃)₂, O₃SCF₃, or O₃SC₄F₉. In other embodiments, the anion is methyl sulfate. In still other embodiments, the anion is hydroxide. In some embodiments, the one or more cationic monomers includes a mixture of two or more of these anions. In some embodiments, polymerization is carried out using 2-(dimethylamino)ethyl acrylate or 2-(dimethylamino)ethyl methacrylate, and the corresponding ammonium functionality is formed in situ by reacting the amino groups present within the polymer with a suitable alkyl halide to form the corresponding ammonium halide functionality. In other embodiments, the ammonium functional monomer is incorporated into the cationic polymer and then the anion is exchanged to provide a different anion. In such embodiments, ion exchange is carried out using any of the conventional processes known to and commonly employed by those having skill in the art.

In various embodiments, the cationic monomer units comprise at least 2 wt % of the polymer, at least 5 wt % of the polymer, or at least 9 wt % of the polymer. In various embodiments, an upper limit on the amount of the cationic monomer units comprised in the polymer may be set at no more than 50 wt % of the polymer, no more than 40 wt % of the polymer, or no more than 30 wt % of the polymer.

In some embodiments, the PSA (meth)acrylate polymer comprising cationic monomer units additionally comprises anionic monomer units, that is, the polymer is zwitterionic. In some such embodiments, the anionic monomer units comprise carboxylic acid groups, including, as representative examples, acrylic acid and methacrylic acid. In the case of zwitterionic polymers, the molar ratio of anionic monomer units present in the polymer to cationic monomer units present in the polymer is less than 1.0 and more preferably less than 0.9, less than 0.8, less than 0.7, or less than 0.6.

Additional embodiments are recited in the Selected Embodiments and Examples below.

### SELECTED EMBODIMENTS

The following embodiments, designated by letter and number, are intended to further illustrate the present disclosure but should not be construed to unduly limit this disclosure.

C1. A fire resistant pressure sensitive adhesive comprising a blend of:

a) a (meth)acrylate polymer comprising cationic monomer units; and

b) a non-halogenated flame retardant.

C2. The adhesive according to any of the preceding embodiments wherein at least 20% of the monomer units of the polymer are derived from (meth)acrylate monomers.
C3. The adhesive according to any of the preceding embodiments wherein at least 50% of the monomer units of the polymer are derived from (meth)acrylate monomers.
C4. The adhesive according to any of the preceding embodiments wherein at least 70% of the monomer units of the polymer are derived from (meth)acrylate monomers.
C5. The adhesive according to any of the preceding embodiments wherein the cationic monomer units comprise cationic quaternary amine groups.
C6. The adhesive according to any of the preceding embodiments wherein the cationic monomer units comprise at least 2 wt % of the polymer.
C7. The adhesive according to any of the preceding embodiments wherein the cationic monomer units comprise at least 5 wt % of the polymer.
C8. The adhesive according to any of the preceding embodiments wherein the cationic monomer units comprise at least 9 wt % of the polymer.
C9. The adhesive according to any of the preceding embodiments wherein the (meth)acrylate polymer additionally comprises anionic monomer units.
C10. The adhesive according to embodiment C9 wherein the anionic monomer units comprise carboxylic acid groups.
C11. The adhesive according to any of embodiments C9 or C10 wherein the molar ratio of anionic monomer units present in the polymer to cationic monomer units present in the polymer is less than 0.9.
C12. The adhesive according to any of the preceding embodiments wherein no flame retardant is covalently bound to the polymer.
C13. The adhesive according to any of the preceding embodiments wherein no phosphorus-containing moiety is covalently bound to the polymer.
C14. The adhesive according to any of the preceding embodiments comprising essentially no common solvents.
C15. The adhesive according to any of the preceding embodiments wherein the polymer comprising cationic monomer units is water soluble.
F1. The adhesive according to any of the preceding embodiments wherein the flame retardant is selected from the group consisting of phosphorus-containing flame retardants, melamine-containing flame retardants, clays, metal hydroxides, and zinc borates.
F2. The adhesive according to any of the preceding embodiments wherein the flame retardant is selected from the group consisting of ammonium pyrophosphate, ammonium polyphosphate, diethyl phosphinate, ethylene diamine phosphate, melamine pyrophosphate, melamine polyzinc phosphate, melamine polymagnesium phosphate, melamine zinc phosphate, piperazine phosphate, pyrophosphoric acid salt, 9,10-dihydro-9-oxa-10-phosphaphenanthrene 10-oxide (DOPO), hydroxyphenyl phosphinyl propanoic acid, magnesium hydroxide, alumina trihydrate, melamine cyanurate, melamine, clay, and zinc borate.
F3. The adhesive according to any of the preceding embodiments wherein the flame retardant comprises phosphorus.
F4. The adhesive according to any of the preceding embodiments wherein the flame retardant comprises phosphate.
F5. The adhesive according to any of the preceding embodiments wherein the flame retardant comprises ammonium phosphate.
F6. The adhesive according to any of the preceding embodiments comprising at least 2 wt % of the flame retardant based on the total weight of polymer plus flame retardant.
F7. The adhesive according to any of the preceding embodiments comprising at least 5 wt % of the flame retardant based on the total weight of polymer plus flame retardant.
F8. The adhesive according to any of the preceding embodiments comprising at least 10 wt % of the flame retardant based on the total weight of polymer plus flame retardant.
F9. The adhesive according to any of the preceding embodiments comprising at least 20 wt % of the flame retardant based on the total weight of polymer plus flame retardant.
F10. The adhesive according to any of the preceding embodiments comprising at least 45 wt % of the flame retardant based on the total weight of polymer plus flame retardant.
F11. The adhesive according to any of the preceding embodiments comprising flame retardant in aqueous solution.
F12. The adhesive according to any of the preceding embodiments comprising at least 1 wt % flame retardant in aqueous solution and additionally comprising at least 1 wt % particulate flame retardant.
F13. The adhesive according to any of the preceding embodiments comprising particulate flame retardant.
F14. The adhesive according to any of embodiments F12 or F13 wherein the particulate flame retardant has median particle size (Dv50) of less than 20 micrometers.
F15. The adhesive according to any of embodiments F12 or F13 wherein the particulate flame retardant has median particle size (Dv50) of less than 18 micrometers.
F16. The adhesive according to any of embodiments F12 or F13 wherein the particulate flame retardant has median particle size (Dv50) of less than 10 micrometers.
F17. The adhesive according to any of embodiments F12 or F13 wherein the particulate flame retardant has median particle size (Dv50) of less than 7 micrometers.
F18. The adhesive according to any of embodiments F12 or F13 wherein the particulate flame retardant has median particle size (Dv50) of less than 6 micrometers.
F19. The adhesive according to any of embodiments F12-F18 wherein the particulate flame retardant has median particle size (Dv50) of at least 1 micrometer.
F20. The adhesive according to any of embodiments F12-F18 wherein the particulate flame retardant has median particle size (Dv50) of at least 2 micrometers.
F21. The adhesive according to any of embodiments F12-F18 wherein the particulate flame retardant has median particle size (Dv50) of at least 4 micrometers.
E 1. An emulsion of the adhesive according to any of the preceding embodiments in water.
E2. The emulsion according to embodiment E1 comprising at least 20% solids.
E3. The emulsion according to embodiment E1 comprising at least 35% solids.
E4. The emulsion according to embodiment E1 comprising at least 50% solids.
T1. An adhesive tape or film comprising a first adhesive layer comprising the fire resistant pressure sensitive adhesive according to any of embodiments C1-C15 or F1-F21.
T2. The adhesive tape or film according to embodiment T1 additionally comprising a supporting layer.
T3. The adhesive tape or film according to embodiment T2 wherein the supporting layer is a foam.
T4. The adhesive tape or film according to embodiment T2 or T3 wherein the supporting layer is flame retardant.
T5. The adhesive tape or film according to any of embodiments T1-T4 additionally comprising a second adhesive layer comprising the fire resistant pressure sensitive adhesive according to any of embodiments C1-C15 or F1-F21.
T6. The adhesive tape or film according to any of embodiments T1-T4 additionally comprising a second adhesive layer comprising the fire resistant pressure sensitive adhesive according to any of embodiments C1-C15 or F1-F21.
T7. The adhesive tape or film according to any of embodiments T1-T6 which has a rating of
V-2 or better in the First Modified UL 94VTM Test Procedure described herein.
U1. The use of the adhesive tape or film according to any of embodiments T1-T4 to join two adherends.
U2. The use of the fire resistant pressure sensitive adhesive according to any of embodiments C1-C15 or F1-F21 to join two adherends.
M1. A method of joining two adherends comprising joining a first adherend to the adhesive tape or film according to any of embodiments T1-T4 and joining a second adherend to the adhesive tape or film.
M2. A method of joining two adherends comprising joining a first adherend to the fire resistant pressure sensitive adhesive according to any of embodiments C1-C15 or F1-F21 and joining a second adherend to the fire resistant pressure sensitive adhesive.

Objects and advantages of this disclosure are further illustrated by the following examples, but the particular materials and amounts thereof recited in these examples, as well as other conditions and details, should not be construed to unduly limit this disclosure.

### EXAMPLES

Unless otherwise noted, all reagents were obtained or are available from Aldrich Chemical Co., Milwaukee, Wis., or may be synthesized by known methods.

All parts, percentages, ratios, etc. in the examples and the rest of the specification are by weight, unless noted otherwise. The following abbreviations may be used:m=meters; cm=centimeters; mm=millimeters; um=micrometers; ft=feet; in=inch; RPM=revolutions per minute; kg=kilograms; oz=ounces; lb=pounds; Pa=Pascals; sec=seconds; min=minutes; hr=hours; and RH=relative humidity. The terms “weight %”, “% by weight”, and “wt %” are used interchangeably.

Materials

| Designation | Description |
|---|---|
| 2-EHA | 2-Ethyl hexyl acrylate, obtained from BASF SE, Ludwigshafen, Germany. |
| Acronal 3633 | An anionic aqueous all-acrylic pressure sensitive dispersion, 60% in water, |
| | obtained under trade designation “ACRONAL 3633” from BASF SE, |
| | Ludwigshafen, Germany. |
| AP420 | Aqueous solution of a short-chain ammonium polyphosphate, 45% in |
| | water, non-halogenated flame retardant, obtained under trade designation |
| | “EXOLIT AP 420” from CLARIANT AG, Frankfurt am Main, Germany. |
| AP422 | A fine-particle ammonium polyphosphate (phase II), having median |
| | particle size (Dv50) of 17 micrometer, non-halogenated flame retardant, |
| | obtained under trade designation “EXOLIT AP 422” from CLARIANT |
| | Plastics & Coatings GmbH Frankfurt am Main, Germany. |
| AP423 | A fine-particle ammonium polyphosphate (phase II), having median |
| | particle size (Dv50) of 8 micrometer, non-halogenated flame retardant, |
| | obtained under trade designation “EXOLIT AP 423” from CLARIANT |
| | Plastics & Coatings GmbH, Frankfurt am Main, Germany. |
| AP423 Dv50 = 5 | A fine-particle grade of AP423, having median particle size (Dv50) of 5 |
| | micrometer, obtained from CLARIANT Plastics & Coatings GmbH, |
| | Frankfurt am Main, Germany. |
| AP423 Dv50 = 6 | A fine-particle grade of AP423, having median particle size (Dv50) of 6 |
| | micrometer, obtained from CLARIANT Plastics & Coatings GmbH, |
| | Frankfurt am Main, Germany. |
| Cloisite 20A | nanoclay, obtained from Southern Clay Products, Gonzales, TX, now |
| | BYK Additives, Gonzales, TX |
| DMAEA-MCL | N,N-dimethylaminoethyl acrylate methyl chloride quaternary, 80% in |
| | water, obtained under the trade designation “AGEFLEX FA1Q80MC” |
| | from BASF SE, Ludwigshafen, Germany. |
| DOPO | 9,10-Dihydro-9-oxa-10-phosphaphenanthrene 10-oxide structure, obtained |
| | from TCI Chemicals, Tokyo, Japan |
| EC-25 | Cocoalkylmethyl[polyoxyethylene (15)] ammonium chloride, 95% |
| | minimum active surfactant solution, obtained under the trade designation |
| | “ETHOQUAD C/25”, from Akzo Nobel N.V., Amsterdam, Netherlands. |
| Firebrake ZB fine | Zinc Borate, obtained from US Borax, Rio Tinto |
| FP2100 | phosphorus nitrogen based flame retardant, obtained from Adeka Europe |
| | GmBH, Dusseldorf, GE |
| FRCros 634 | aqueous solution of short chain ammonium polyphosphate, 61% in water, |
| | obtained from Budenheim in Budenheim, GE |
| H2O5 | hydroxyphenyl phosphinyl propanoic acid, obtained from Kolon |
| | Industries, Seoul, Korea |
| Intumax AC-2 | intumescent phosphate based flame retardant, obtained from Broadview |
| | Technologies, Newark, NJ |
| Intumax AC-3 | phosphate based flame retardant, obtained from Broadview |
| | Technologies, Newark, NJ |
| IOA | Isooctyl acrylate, obtained from 3M Company, St. Paul, MN |
| MAA | Methacrylic acid, obtained from Alfa Aesar, Ward Hill, MA. |
| Melafine | Melamine, obtained from OCT Melamine-OCI Nitrogen, |
| | Geleen, The Netherlands |
| Melapur MC50 | melamine cyanurate, obtained from BASF, Florham Park, NJ |
| Micral 1500 | aluminum trihydrate, obtained from Huber Engineered |
| | Materials, Edison, NJ |
| OP935 | organic phosphinate, obtained from Clariant AG, |
| | Frankfurt am Main, Germany |
| Robond PS-8915 | An anioinic aqueous acrylic pressure sensitive emulsion, 55% in water, |
| | obtained under trade designation “ROBOND PS-9550” from Dow, |
| | Midland, MI. |
| Safire 3000 | melamine zinc phosphate + DOPO, obtained from Huber Engineered |
| | Materials, Edison, NJ |
| Safire 400 | melamine polyzinc phosphate, obtained from Huber Engineered Materials, |
| | Edison, NJ |
| Safire 600 | melamine polymagnesium phosphate, obtained from Huber Engineered |
| | Materials, Edison, NJ |
| SB-632 | Aluminum trihydrate mechanically produced powder obtained from Huber |
| | Engineered Materials, Edison, NJ |
| Snowtack 780G | SNOWTACK SE 780G is a 55% solids, water-borne tackifier dispersion |
| | based on rosin adduction and esterification, obtained from |
| | Lawter Inc. Chicago, IL |
| Standard IOA | 3M ™ Fastbond ™ Insulation Adhesive 49, a water-based anionic acrylic |
| Adhesive | polymer adhesive, obtained from the 3M Company, St. Paul, MN |
| V-50 | 2,2′-Azobis (2-amidinopropane) dihydrochloride, obtained from Wako |
| | Chemicals USA, Richmond, VA. |
| VA | Vinyl acetate, obtained from Alfa Aesar, Ward Hill, MA. |
| Vertex 100 | magnesium hydroxide, obtained from Huber |
| | Engineered Materials, Edison, NJ |
| Zuran 484 | pyrophosphoric acid salts, obtained from Chitec, Taipei City, Taiwan |

### Synthesis of Cationic Water-Based Emulsion Polymer (CatPoly)

Cationic water-based emulsion polymer (CatPoly) was made according to patent application WO 2014/093375 A1. A 0.95 liter (32 ounce) glass bottle was charged with 85 g IOA followed by addition of 10 g DMAEA-MCL, 2 g MAA, 5 g VA, 100 g water, 1 g EC-25, and 0.375 g V-50. The reaction mixture was purged with nitrogen for two minutes, after which the bottle was sealed tight with a plastic cap. Next, the bottle was rotated in a water bath set at 50° C. for 24 hours. The pH of the resulting solution was adjusted to between 5 and 5.5 by adding aqueous sodium hydroxide solution, followed by filtering through a PET-50GG-355 mesh having an opening of 355 micrometers (available from Sefar Incorporated, Buffalo, N.Y.). The amount of filtered coagulum was typically less than 1% by weight of the total amount of monomer, unless otherwise noted. The resulting emulsion was found to contain less than 0.5% wt. percent unreacted monomer by gravimetric analysis.

### Solution Preparation

Flame retardant additives were directly added to the CatPoly emulsion in a 40 milliliter glass vial in the amounts indicated in Table 1, then mixed using a vortex mixer for two minutes.

### Testing Procedures

### First Modified UL 94VTM Test Procedure

Specimens were prepared as follows. Emulsions were applied on a 51 micrometer (2 mil) thick PET sheet. A Myer Rod, size 30, was used to draw down the solutions to the desired thickness. The drawn down sample was then dried under forced hot air. Once dried, the sample was folded adhesive to adhesive then specimen strips were cut to the following dimensions: Length 125 mm (5 in)×Width 12.5 mm (0.5 in). Total thickness was typically 0.152 micrometers (6 mils), including 2 PET sheets sandwiching 51 micrometers (2 mil) of adhesive.

Three replicates of each specimen were tested. Each specimen was mounted with its long axis vertical. Each specimen was supported such that its lower end was 10 mm above Bunsen burner tube. A blue 20 mm high flame was applied to the center of the lower edge of the specimen for 3 seconds and removed. If burning ceases within 30 seconds, the flame was reapplied for an additional 3 seconds. If the specimen dripped, particles were allowed to fall onto a layer of dry absorbent surgical cotton placed 300 mm below the specimen.

Specimens were rated V-0 (best), V-1, or V-2 as described below. Results are reported in Table 2.

### Second Modified UL 94VTM Test Procedure

The Second Modified UL94VTM test procedure differed from the First Modified UL94VTM test procedure described above in that it used a different specimen preparation. 1.0 mil (25 micrometer) thick adhesive was laminated between 0.5 mil (13 micrometer) PET film and 0.5 mil (13 micrometer) aluminized PET film.

### Requirements for V-0

The specimens may not burn with flaming combustion for more than 10 seconds after either application of the test flame. The total flaming combustion time may not exceed 50 seconds for the 10 flame applications for each set of 5 specimens. The specimens may not burn with flaming or glowing combustion up to the holding clamp. The specimens may not drip flaming particles that ignite the dry absorbent surgical cotton located 300 mm below the test specimen. The specimens may not have glowing combustion that persists for more than 30 seconds after the second removal of the test flame.

### Requirements for V-1

The specimens may not burn with flaming combustion for more than 30 seconds after either application of the test flame. The total flaming combustion time may not exceed 250 seconds for the 10 flame applications for each set of 5 specimens. The specimens may not burn with flaming or glowing combustion up to the holding clamp. The specimens may not drip flaming particles that ignite the dry absorbent surgical cotton located 300 mm below the test specimen. The specimens may not have glowing combustion that persists for more than 60 seconds after the second removal of the test flame.

### Requirements for V-2

The specimens may not burn with flaming combustion for more than 30 seconds after either application of the test flame. The total flaming combustion time may not exceed 250 seconds for the 10 flame applications for each set of 5 specimens. The specimens may not burn with flaming or glowing combustion up to the holding clamp. The specimens can drip flaming particles that ignite the dry absorbent surgical cotton located 300 mm below the test specimen. The specimens may not have glowing combustion that persists for more than 60 seconds after the second removal of the test flame.

### Burn Length

The final length of the strip is measured after the First Modified UL 94VTM flame test procedure and the burn length is calculated as the initial strip length minus the final length after the burn.

### Emulsion Viscosity

Viscosity of emulsions was determined by DV1 Brookfield viscometer obtained from AMETEK Brookfield, Middleboro, MA. A sample of 400-600 ml in a suitable container is placed under the viscometer which is then lowered to dip LV-3 (63) spindle into the sample up to an immersion mark on the spindle shaft. The test is run between 5-60 rpm spindle speed.

### Coating Uniformity

Uniformity of coatings was determined by visual inspection of the coating after spreading into the coating thickness. A uniform coating would have no visible particles, chunks or streaks.

### Microcombustion Calorimetry Test Procedure

Microcombustion calorimetry (MCC), also known as Pyrolysis Combustion Flow calorimetry (PCFC), is used to measure the rate at which the heat of combustion of gases are released by a solid during controlled pyrolysis in an inert gas stream. The volatile products are then mixed with excess oxygen and combusted at high temperature.

The instrument used was Govmark Microscale Combustion calorimeter, Model MCC-2. The procedure used was ASTM D7309.

For each run, a sample of ˜2 mg adhesive was accurately weighed and heated to 900° C. at a heating rate of about 1° C./s in a stream of nitrogen flowing at 80 cc/min. The volatile thermal degradation products were then mixed with pure oxygen at a flow rate of 20 cc/min prior to entering the combustion chamber maintained at 900° C.

The parameters measured included total heat release (THR); heat release capacity (HRC) and percentages of char residues.

### EXAMPLES

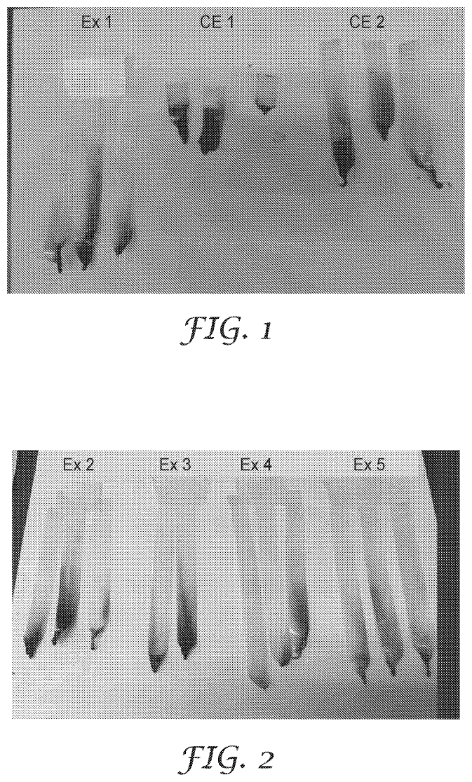

Water-based adhesives with phosphate-based flame retardants were formulated according to the procedures described above as indicated in Table 1. Results are reported in Table 2. FIG. 1 is a photograph of the test strips of Example 1 and Comparative Examples CE1 and CE2, three samples each, after the First Modified UL 94VTM flame test procedure was performed.

TABLE 1
Formulations of water-based adhesives with
phosphate-based flame retardants

| | Water-based Adhesive | | | | | |
|---|---|---|---|---|---|---|
| | | Acronal | Robond | | | |
| | CatPoly | 3633 | PS-8915 | | Flame Retardant Additive | |
| | (50% in | (60% in | (55% in | DI | AP420 (45% | |
| Example # | water) | water) | water) | Water | in water) | AP423 |
| Ex 1 | 10 g | | | | 2 g | 1.5 g |
| CE 1 | | 10 g | | 2 g | 2 g | 1.5 g |
| CE 2 | | | 10 g | 1 g | 2 g | 1.5 g |

Deionized (DI) water was added to CE 1 & CE 2 to adjust the solution solids to the same level as in Ex 1.

TABLE 2
Solution Viscosity, Coating Uniformity and First
Modified UL 94VTM burn testing performance

| | | | | | Burn |
|---|---|---|---|---|---|
| Example | Solution | Coating | First Modified UL 94VTM Test Results | | Length |
| # | Viscosity | Uniformity | Rating | Observation | (cm) |
| Ex 1 | Medium | Uniform | V-2, V-2, | Single drip on | 1.7, 1, 1.5 |
| | 300-800 cPs | | V-2 | second test strip | |
| CE 1 | Low Viscosity | Solids grits, | FDIC, | Continually drips | 12.7, 12.7, |
| | <300 cPs | grainy | FDIC, | | 12.7 |
| | | | FDIC | | (to top) |
| CE 2 | Very High Gel | Uniform | FDIC, | Flames and | 5, 4.5, 7 |
| | >10,000 cPs | | FDIC, | drips easily. | |
| | | | FDIC | | |

“FDIC” indicates test failure with Flame Drips and Ignites Cotton.

### EXAMPLES 2-5

Additional water-based adhesives comprising phosphate-based flame retardants of varying median particle size (Dv50) were formulated according to the procedures described above as indicated in Table 3. The First Modified UL 94VTM flame test procedure was performed on three samples of each and the results reported in Table 3. FIG. 2 is a photograph of the test strips of Examples 2-5 after the First Modified UL 94VTM flame test procedure was performed.

TABLE 3
Formulations of CatPoly with flame retardants of varying particle size

| | Water- | | | | | | First | |
|---|---|---|---|---|---|---|---|---|
| | based | | | | | | Mod- | |
| | Adhesive | Flame Retardant Additive | | | | | ified | Burn |
| Exam | CatPoly | AP420 | AP422 | AP423 | AP423 | AP423 | UL | Len- |
| ple | (50% in | (45% in | Dv50 | Dv50 | Dv50 | Dv50 | 94 | gth |
| # | water) | water) | = 17 | = 8 | = 6 | =5 | Rating | (cm) |
| Ex 2 | 10 g | 2 g | 1.5 g | | | | V-2, | 1.8,2, |
| | | | | | | | V-2, | 1.9 |
| | | | | | | | V-2 | |
| Ex 3 | 10 g | 2 g | | 1.5 g | | | V-2, | 1.7, 1, |
| | | | | | | | V-2, | 1.5 |
| | | | | | | | V-2 | |
| Ex 4 | 10 g | 2 g | | | 1.5 g | | V-0, | |
| | | | | | | | V-2, | 0.5, 1, |
| | | | | | | | V-2 | 1 |
| Ex 5 | 10 g | 2 g | | | | 1.5 g | V-2, | |
| | | | | | | | V-2, | 0.3, |
| | | | | | | | V-2 | 0.5, 1 |

Dv50 is the median particle size in micrometers.

It can be seen from FIG. 2 that the performance of the adhesives in the First Modified UL 94VTM flame test procedure improved with the use of ammonium polyphosphate powders having smaller particle size, where the final strip length remaining was larger with smaller particle size.

### Examples 6-24

Pairs of water-based adhesives comprising a variety of flame retardants were formulated according to the procedures described above, by mixing the flame retardant with Standard IOA Adhesive in one trial and CatPoly in a second trial, as indicated in Table 4. Observations as to the condition of the mixtures are reported in Table 4. Gelling and clumping were considered failures. Blends that mixed well were considered “good”.

TABLE 4

| | | wt % FR | after mixing | |
|---|---|---|---|---|
| | flame retardant | in final | in Standard | after mixing |
| Ex # | (FR) used | adhesive | IOA Adhesive | in CatPoly |
| Ex 6 | AP420 | ~5% | gel | good |
| Ex 7 | FRCros 634 | ~5% | gel | good |
| Ex 8 | AP423 | 10% | gel | good but |
| | | | | viscous |
| Ex 9 | OP935 | 10% | clumpy | good but |
| | | | | grainy, gelling |
| | | | | overtime? |
| Ex 10 | Intumax AC-3 | 10% | gel | good |
| Ex 11 | Intumax AC-2 | 10% | gel | good |
| Ex 12 | Safire 400 | 10% | gel | good but small |
| | | | | particles |
| Ex 13 | Safire 600 | 10% | started as small | good |
| | | | clumps, but then | |
| | | | completely gelled | |
| Ex 14 | Safire 3000 | 10% | gel | good |
| Ex 15 | FP2100 | 10% | gel | good but gritty |
| Ex 16 | Zuran 484 | 10% | gel | good |
| Ex 17 | DOPO | 10% | fairly good | good |
| Ex 18 | H2O5 | 10% | slightly better | good |
| | | | than DOPO | |
| Ex 19 | Vertex 100 | 10% | good with | good |
| | | | very small | |
| | | | clumps, gelling? | |
| Ex 20 | Micral 1500 | 10% | clumpy | good |
| | | | but mixed | |
| Ex 21 | Melapur MC50 | 10% | good | good |
| Ex 22 | Melafine | 10% | gel | good |
| Ex 23 | Cloisite 20A | 10% | gel | good |
| Ex 24 | Firebrake ZB fine | 10% | good at first, | good |
| | | | became like | |
| | | | cottage cheese | |

Water-based acrylates do not blend well with a majority of common, non-halogenated flame retardants, even at relatively small amounts of 10 wt %. However, using cation-containing acrylic polymer such as CatPoly as the adhesive polymer allows blending with common phosphorus-based and other inorganic flame retardants without gelling.

### Examples 25 & 26 and Comparative Example 3

Additional water-based adhesives were formulated according to the procedures described above as indicated in Table 5. For Example 25, 100 parts (by weight) CatPoly was blended with 9 parts AP420 and 18 parts AP423 (Dv50=8). For Example 26, 100 parts (by weight) CatPoly was blended with 12 parts AP420, 20 parts AP423 (Dv50=5), 20 parts Snowtack 780G, and 5 parts SB-632. The Second Modified UL 94VTM flame test procedure and microcombustion calorimetry (MCC) were performed on each of Examples 25 & 26 and Comparative Example 3 and the results are reported in Table 5.

TABLE 5

| | | MCC: | | Second |
|---|---|---|---|---|
| | | Total heat | | Modified |
| | | release | MCC: | UL94 |
| Example # | Composition | (KJ/g) | % char | test result |
| CE 3 | CatPoly only | 28.5 | 1 | Fail |
| Ex 25 | CatPoly, AP420, and | 19 | 22 | Pass |
| | AP423 (Dv50 = 8) | | | |
| Ex 26 | CatPoly, AP420, | 17 | 27 | Pass |
| | AP423 (Dv50 = 5), | | | |
| | Snowtack 780G, | | | |
| | and SB-632 | | | |

CatPoly-based PSA blends were found to tolerate very high loadings while retaining low viscosity and good processability (determined by observation). CatPoly adhesive can contain up to at least 50 wt % fillers and still have a low enough viscosity to process easily (determined by observation).

Microcombustion calorimetry (MCC) results indicated excellent flame retardance for Examples 25 & 26. Lower total heat release and higher char formation indicate better flame retardance.

Various modifications and alterations of this disclosure will become apparent to those skilled in the art without departing from the scope and principles of this disclosure, and it should be understood that this disclosure is not to be unduly limited to the illustrative embodiments set forth hereinabove.

1. A fire: resistant pressure sensitive adhesive comprising a blend of:
a) a (meth)acrylate polymer comprising cationic monomer units; and
b) a non-halogenated flame retardant.

2. The fire-resistant pressure sensitive adhesive according to claim 1, wherein the cationic monomer units comprise cationic quaternary amine groups.

3. The fire-resistant pressure sensitive adhesive according to claim 1, wherein the cationic monomer units comprise at least 2 wt % of the (meth)acrylate polymer.

4. The fire-resistant pressure sensitive adhesive according to claim 1, wherein the (meth)acrylate polymer additionally comprises anionic monomer units, and wherein the molar ratio of anionic monomer units present in the (meth)acrylate polymer to cationic monomer units present in the (meth)acrylate polymer is less than 0.9.

5. The fire-resistant pressure sensitive adhesive according to claim 1 comprising essentially no common solvents.

6. The fire-resistant pressure sensitive adhesive according to claim 1 wherein the non-halogenated flame retardant is selected from the group consisting of phosphorus-containing flame retardants, melamine-containing flame retardants, clays, metal hydroxides, and zinc borates.

7. The fire-resistant pressure sensitive adhesive according to claim 1, wherein the non-halogenated flame retardant is selected from the group consisting of ammonium pyrophosphate, ammonium polyphosphate, diethyl phosphinate, ethylene diamine phosphate, melamine pyrophosphate, melamine polyzinc phosphate, melamine polymagnesium phosphate, melamine zinc phosphate, piperazine phosphate, pyrophosphoric acid salt, 9,10-44dihydro-9-oxa-10-phosphaphenanthrene 10-oxide, hydroxyphenyl phosphinyl propanoic acid, magnesium hydroxide, alumina trihydrate, melamine cyanurate, melamine, clay, and zinc borate.

8. The fire-resistant pressure sensitive adhesive according to claim 1 wherein the non-halogenated flame retardant comprises phosphorus.

9. The fire-resistant pressure sensitive adhesive according to claim 1, wherein the non-halogenated flame retardant comprises phosphate.

10. The fire-resistant pressure sensitive adhesive according to claim 1 comprising at least 2 wt % of the non-halogenated flame retardant based on the total weight of the (meth)acrylate polymer plus the non-halogenated flame retardant.

11. The fire-resistant pressure sensitive adhesive according to claim 1 comprising at least 5 wt % of the non-halogenated flame retardant based on the total weight of the (meth)acrylate polymer plus the non-halogenated flame retardant.

12. The fire-resistant pressure sensitive adhesive according to claim 1 comprising at least 20 wt % of the non-halogenated flame retardant based on the total weight of the (meth)acrylate polymer plus the non-halogenated flame retardant.

13. The fire-resistant pressure sensitive adhesive according to claim 1 comprising at least 35 wt % of the non-halogenated flame retardant based on the total weight of the (meth)acrylate polymer plus the non-halogenated flame retardant.

14. The fire-resistant pressure sensitive adhesive according to claim 1 comprising the non-halogenated flame retardant in aqueous solution.

15. The fire-resistant pressure sensitive adhesive according to claim 1 comprising at least 1 wt % of the non-halogenated flame retardant in aqueous solution and additionally comprising at least 1 wt % particulate non-halogenated flame retardant.

16. The fire-resistant pressure sensitive adhesive according to claim 1, wherein the non-halogenated flame retardant comprises a comprising particulate non-halogenated flame retardant.

17. The fire-resistant pressure sensitive adhesive according to claim 16, wherein the particulate non-halogenated flame retardant has median particle size (Dv50) of less than 20 micrometers.

18. The fire-resistant pressure sensitive adhesive according to claim 16, wherein the particulate non-halogenated flame retardant has median particle size (Dv50) of less than 10 micrometers.

19. The fire-resistant pressure sensitive adhesive according to claim 16, wherein the particulate non-halogenated flame retardant has median particle size (Dv50) of less than 7 micrometers.

20. An adhesive tape or film comprising a first adhesive layer comprising the fire-resistant pressure sensitive adhesive according to claim 1 and a supporting layer, wherein the adhesive tape or film has a rating of V-2 or better in the First Modified UL 94VTM Test Procedure described herein.
